(19) United States
(12) Patent Application Publication
(10) Pub. No.: US 2009/0226394 A1
(43) Pub. Date: Sep. 10, 2009

(54) BIOCIDAL COATINGS

(75) Inventors: Simon Champ, Ludwigshafen (DE); Hermann Seyffer, Heidelberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/913,614

(22) PCT Filed: May 3, 2006
(86) PCT No.: PCT/EP2006/062014

§ 371 Date: Nov. 5, 2007

(30) Foreign Application Priority Data
May 4, 2005 (DE) 10 2005 021 363.4

(51) Int. Cl. A01N 33/02; A01N 33/00; A01P 1/00

(52) U.S. Cl. 424/78.35

(57) ABSTRACT

The use of a cationic polymer as a biocidal active substance, wherein no other biocidal active substances, in particular no quaternary ammonium salts, are concomitantly used, the polymer is a polyethylenimine which comprises at least 95% by weight of units of the formula

—CH2-CH2-N I

in which N is a primary, secondary, tertiary or quaternary nitrogen atom, or a polyvinylamine which comprises at least 95% by weight of ethylenically unsaturated compounds capable of free radical polymerization and having a primary, secondary, tertiary or quaternary amino group in polymerized form, and the polymer comprises from 0.1 to 22 milliequivalents of cationic groups per gram of polymer.

The invention relates to the use of a cationic polymer as a biocidal active substance, wherein no other biocidal active substances, in particular no quaternary ammonium salts, are concomitantly used, the polymer is a polyethylenimine which comprises at least 95% by weight of units of the formula

—CH2-CH2-N I

in which N is a primary, secondary, tertiary or quaternary nitrogen atom, or a polyvinylamine which comprises at least 95% by weight of ethylenically unsaturated compounds capable of free radical polymerization and having a primary, secondary, tertiary or quaternary amino group in polymerized form, and the polymer comprises from 0.1 to 22 milliequivalents of cationic groups per gram of polymer.

The invention also relates to substrates which are treated with the biocidal active substance and are obtainable by coating, impregnation or other treatment of the desired substrates with the polymer or the solution or dispersion of the polymer.

Biocidal active substances kill microorganisms, such as bacteria, fungi, yeasts, algae or viruses, or prevent at least their reproduction and/or growth.

In the case of a very wide range of substrates, there is the desire for and often also the necessity of a biocidal treatment. These are, for example, substrates for medical applications, applications in the sanitary or hygiene sector, in the food sector, in particular in food packagings, or substrates for various industrial applications, in particular filters, e.g. for air conditioning systems.

WO 2004/087226 discloses such substrates treated with biocidal active substances. The biocidal active substance used is a mixture of cationic polymers and special quaternary ammonium salts.

U.S. Pat. No. 6,261,581, and DE-A-19608555 disclose the use of polyvinylamine and polyethylenimine copolymers as biocidal active substances. Polyvinylamine and polyethylenimine homopolymers are covered by the formula stated in U.S. Pat. No. 6,261,581, but only copolymers are disclosed in specific form in the description.

More economical biocidal active substances and a simpler process for the biocidal treatment of substrates were the object of the present invention.

Accordingly, the use defined at the outset was found.

### Regarding the Polyethylenimines

The polyethylenimines preferably comprise at least 99% by weight, particularly preferably at least 100% by weight, of the above units CH2-CH2-N.

The nitrogen atom N may be a primary, secondary or tertiary nitrogen atom. Primary nitrogen atoms may be present in particular as an NH2 group at the chain end, secondary N atoms are as —NH— a constituent of polymer chains and tertiary N atoms are crosslinking points to which 3CH2-CH2 groups are bonded.

Some of the N atoms carry a positive charge, i.e. are quaternized. Quaternization of the N atoms can be achieved by adjusting the ph; in the acidic range, the corresponding part of the N atoms is protonated.

Quaternization of the polyethylenimines can also be carried out, for example, with alkyl halides, such as methyl chloride, ethyl chloride, hexyl chloride, benzyl chloride or lauryl chloride, and with, for example, dimethyl sulfate.

The homopolymers are prepared, for example, by polymerization of ethylenimine in aqueous solution in the presence of acids, Lewis acids or alkylating agents, such as methyl chloride, ethyl chloride, propyl chloride, ethylene chloride, chloroform or tetrachloroethylene. The polyethylenimines thus obtainable have a broad molar mass distribution and average molar masses Mw of, for example, from 120 to 2·106, preferably from 430 to 1·106. The average molar masses Mw of the suitable polyethylenimines may be up to 2 million and preferably may be in the range from 1000 to 50 000.

The polyethylenimine preferably comprises from 0.1 to 22 milliequivalents, particularly preferably from 4 to 10 milliequivalents, of cationic groups per gram of polyethylenimine.

### Regarding the Polyvinylamines

The polyvinylamine is a polymer which is composed of at least 95% by weight, preferably at least 99% by weight and very particularly preferably 100% by weight of ethylenically unsaturated compounds capable of free radical polymerization and having a primary, secondary, tertiary or quaternary amino group, i.e. is obtainable from these monomers by polymerization.

In particular, such monomers are vinylcarboxamides which comprise in particular secondary and tertiary amino groups in the form of substituted amido groups and the monomers obtainable from these vinylcarboxamides by hydrolysis and having primary amino groups.

Polymers as used in the context of the present invention are known, cf. U.S. Pat. No. 4,421,602, U.S. Pat. No. 5,334,287, EP-A 216 387, U.S. Pat. No. 5,981,689, WO 00/63295, U.S. Pat. No. 6,121,409 and U.S. Pat. No. 6,132,558. They are prepared in general by hydrolysis of open-chain polymers comprising N-vinylcarboxamide units. These polymers are obtainable, for example, by polymerization of N-vinylformamide, N-vinyl-N-methylformamide, N-vinylacetamide, N-vinyl-N-methylacetamide, N-vinyl-N-ethylacetamide and N-vinylpropionamide. Said monomers can be polymerized either alone or together with other monomers. N-vinylformamide is preferred.

The polymerization of the monomers is usually carried out in the presence of polymerization initiators forming free radicals. The homo- and copolymers can be obtained by all known processes; for example, they are obtained by solution polymerization in water, alcohols, ethers or dimethylformamide or in mixtures of different solvents, by precipitation polymerization, inverse suspension polymerization (polymerization of an emulsion of a monomer-containing aqueous phase in an oil phase) and polymerization of a water-in-water emulsion, for example in which an aqueous monomer solution is dissolved or emulsified in an aqueous phase and polymerization is carried out with formation of an aqueous dispersion of a water-soluble polymer, as described, for example, in WO 00/27893. After the polymerization, the homo- and copolymers which comprise N-vinylcarboxamide units incorporated in the form of polymerized units are partly or completely hydrolyzed as described below.

It is preferable to start from homopolymers of N-vinylformamide or from copolymers of vinylcarboxamides, in particular N-vinylformamide, with other vinylcarboxamides; units having primary amino groups form by subsequent hydrolysis of the homo- or copolymers, the degree of hydrolysis being, for example, from 1 to 100 mol %, preferably from 25 to 100 mol %, particularly preferably from 50 to 100 mol % and especially preferably from 70 to 100 mol %. The degree of hydrolysis corresponds to the content of primary vinylamine groups in the polymers, in mol %. The hydrolysis of the polymers described above is effected by known processes, by the action of acids (e.g. mineral acids, such as sulfuric acid, hydrochloric acid or phosphoric acid, carboxylic acids, such as formic acid or acetic acid, or sulfonic acids or phosphonic acids), bases or enzymes, as described, for example, in DE-A 31 28 478 and U.S. Pat. No. 6,132,558. With the use of acids as hydrolysis agents, the vinylamine units of the polymers are present as an ammonium salt, while the free amino groups form in the hydrolysis with bases.

The average molar masses Mw of the polymers comprising vinylamine units are, for example, from 500 to 10 million, preferably from 750 to 5 million and particularly preferably from 1000 to 2 million g/mol (determined by light scattering). This molar mass range corresponds, for example, to K values of from 30 to 150, preferably from 60 to 100 (determined according to H. Fikentscher in 5% strength aqueous sodium chloride solution at 25° C., a pH of 7 and a polymer concentration of 0.5% by weight). Particularly preferably used polymers comprising vinylamine units are those which have K values of from 85 to 95.

Preferably, the polyvinylamine comprises from 0.1 to 22 milliequivalents (meq), particularly preferably from 10 to 20 meq, of cationic groups per gram of polyvinylamine.

The polymers comprising vinylamine units are preferably used in salt-free form. Salt-free aqueous solutions of polymers comprising vinylamine units can be prepared, for example, from the salt-containing polymer solutions described above with the aid of ultrafiltration of suitable membranes with cut-offs of, for example, from 1000 to 500 000 dalton, preferably from 10 000 to 300 000 dalton.

Preferred polyvinylamines are homopolymers of N-vinylformamide having a degree of hydrolysis of from 1 to 100 mol %, preferably from 25 to 100 mol % and from 1 to 100 mol %.

Typical members of these homopolymers of N-vinylformamide are known under the trade names Catiofast® VFH, Catiofast® VSH and Catiofast® VMP of BASF Aktiengesellschaft.

The polyethylenimine and polyvinylamine are preferably used in the form of an aqueous dispersion or solution.

Biocidally treated substrates are obtainable by coating, impregnating or otherwise treating the desired substrates with the polyethylenimine or the polyvinylamine or the solution or dispersion thereof. The treatment with the solution or dispersion can be effected at room temperature; after drying, the substrate has a corresponding treatment.

The amount of polymer is preferably from 0.001 to 1000 mg, particularly preferably from 0.1 to 10 mg, of polymer per square meter of surface of the substrate to be treated with the biocide.

The biocide is suitable for substrates comprising natural or synthetic polymers, paper or metal.

The polyethylenimine and polyvinylamine are suitable as the sole biocide, i.e. the addition of further biocidal compounds, for example of quaternary ammonium salts, as described in WO 2004/087226, is not necessary.

The substrates treated with the biocide may be, for example, substrates for medical applications, applications in the sanitary or hygiene sector, in the food sector, in particular in food packagings, or substrates for various industrial applications, in particular filters, e.g. for air conditioning systems.

The biocides can also be added to detergents and cleaning agents.

The biocides have an outstanding action against microorganisms, such as viruses, yeasts, fungi and in particular against bacteria.

### EXAMPLES

### Production of Paper Treated with the Biocide

A base paper having a weight of 120 g/square meter was produced from a 1% by weight suspension of birch and pine fibers (30/70%) using a Rapid Köthen paper former. The paper was dried on a cylinder dryer at 90° C. to a water content of 5% by weight and cut into 4×4 cm wide strips.

These strips were introduced for 10 minutes into 25 ml into a polyethylenimine or polyvinylamine solution according to table 1 (concentration of the polymer 10 mg/ml). Thereafter, the strip was added for 5 minutes to demineralized water and then dried at 90° C. at a residual water content of 5% by weight.

TABLE 1

| | | Molecular weight | Charge density |
|---|---|---|---|
| Example | Polymer | (kilodalton) | meq/g at pH 7 |
| Comparison | — | — | — |
| 1 | PEI | 20 000 | 8 |
| 2 | PEI | 200 | 8 |
| 3 | PEI | 20 | 8 |
| 4 | PVAm | 2000 | 18 |
| 5 | PVAm | 200 | 18 |
| 6 | PVAm | 20 | 18 |

Abbreviations. PEI: polyethylenimine; PVAm: polyvinylamine

### Biocidal Action

Gram negative bacteria (Escherichia Coli, E.C.) and gram positive bacteria (Staphylococcus Aureus, S.A.) were suspended in a salt solution (0.9% by weight of NaCl). The optical density of the solution was measured at 420 nm. The content of E.C. and S.A. was 1.9 times 10 to the power of 9 and 2.1 times 10 to the power of 9, respectively, per ml.

The papers according to table 1 were incubated with 60 minutes with 30 ml of the bacteria solutions. The papers were then removed from the bacteria suspension and the optical density determined again.

Escherichia Coli

| | Optical density at | Optical density after | |
|---|---|---|---|
| Example | the beginning | 30 minutes | Difference |
| Comparison | 0.176 | 0.177 | 0.001 |
| 1 | 0.182 | 0.022 | 0.160 |
| 2 | 0.176 | 0.012 | 0.154 |
| 3 | 0.167 | 0.031 | 0.136 |
| 4 | 0.191 | 0.011 | 0.180 |
| 5 | 0.177 | 0.035 | 0.142 |
| 6 | 0.195 | 0.056 | 0.139 |

Staphylococcus aureus

| | Optical density at | Optical density after | |
|---|---|---|---|
| Example | the beginning | 30 minutes | Difference |
| Comparison | 0.176 | 0.176 | 0.001 |
| 1 | 0.173 | 0.033 | 0.14 |
| 2 | 0.180 | 0.044 | 0.136 |
| 3 | 0.170 | 0.021 | 0.149 |
| 4 | 0.182 | 0.052 | 0.130 |
| 5 | 0.176 | 0.012 | 0.164 |
| 6 | 0.193 | 0.041 | 0.152 |

The decrease in the optical density is an indication of the destruction of the bacteria and the associated elimination of the bacteria.

1. A biocidal active substance comprising a cationic polymer, wherein no other biocidal active substances or quaternary ammonium salts are concomitantly included, said polymer consisting of a polyethylenimine which comprises at least 95% by weight of units of the formula
—CH2-CH2-N I
in which N is a primary, secondary, tertiary or quaternary nitrogen atom, or a polyvinylamine which comprises at least 95% by weight of ethylenically unsaturated compounds capable of free radical polymerization and having a primary, secondary, tertiary or quaternary amino group in polymerized form, wherein said polymer comprises from 0.1 to 22 milliequivalents of cationic groups per gram of polymer.

2. The biocidal active substance according to claim 1, wherein said polymer is used in the form of an aqueous solution or dispersion.

3. A biocidally treated substrate obtained by coating, impregnating or otherwise treating the desired substrate with the polyethylenimine or the polyvinylamine according to claim 1 or a solution or dispersion thereof.

4. The biocidally treated substrate according to claim 3, wherein said substrate has from 0.001 to 1000 mg of polymer per square meter of surface.

5. The biocidally treated substrate according to claim 3, which is a substrate comprising natural or synthetic polymers, paper or metal.

6. The biocidally treated substrate according to claim 4, which is a substrate comprising natural or synthetic polymers, paper or metal.
